(19) United States
(12) Patent Application Publication
(10) Pub. No.: US 2026/0065403 A1
(43) Pub. Date: Mar. 5, 2026

(54) ELECTRONIC APPARATUS FOR EMBEDDING AND EXTRACTING WATERMARK AND CONTROLLING METHOD THEREOF

(71) Applicant: SAMSUNG ELECTRONICS CO., LTD., Suwon-si (KR)

(72) Inventors: Jinmok KIM, Suwon-si (KR); Juseong LEE, Suwon-si (KR); Seok HONG, Suwon-si (KR)

(73) Assignee: SAMSUNG ELECTRONICS CO., LTD., Suwon-si (KR)

(21) Appl. No.: 19/347,072

(22) Filed: Oct. 1, 2025

Related U.S. Application Data
(63) Continuation of application No. PCT/KR2025/008497, filed on Jun. 19, 2025.

(30) Foreign Application Priority Data
Sep. 4, 2024 (KR) 10-2024-0120390
Sep. 24, 2024 (KR) 10-2024-0128988

(51) Int. Cl. G06T 1/00

(52) U.S. Cl. CPC G06T 1/0021; G06T 2201/0052

(57) ABSTRACT

An electronic apparatus includes: at least one processor including processing circuitry; and memory storing instructions, wherein the instructions, when executed by the at least one processor individually or collectively, cause the electronic apparatus to: obtain information on sizes of frequency components for a plurality of color channels constituting an image, identify a color channel having a size ratio of a high frequency component that is highest among the plurality of color channels, based on a size of the high frequency component of the identified color channel for each of a plurality of areas constituting the image, identify an embedding strength of a watermark for each of the plurality of areas, embed, into the watermark, (i) information corresponding to the embedding strength for each of the plurality of areas and (ii) locations of each of the plurality of areas, and embed, into the image, the watermark.

### CROSS-REFERENCE TO RELATED APPLICATIONS

This application is a by-pass continuation application of International Application No. PCT/KR2025/008497, filed on Jun. 19, 2025, which is based on and claims priority to Korean Patent Application No. 10-2024-0120390, filed on Sep. 4, 2024, with the Korean Intellectual Property Office, and Korean Patent Application No. 10-2024-0128988, filed on Sep. 24, 2024, with the Korean Intellectual Property Office, the disclosures of which are incorporated by reference herein in their entireties.

### BACKGROUND

### 1. Field

The disclosure relates to an electronic apparatus and a controlling method thereof, and more particularly, to an electronic apparatus that embeds a watermark into an image, or extracts an embedded watermark from an image into which the watermark was embedded, and a controlling method thereof.

### 2. Description of Related Art

In a digital environment, various technologies for protection of copyrighted images are being used. Among them, a watermarking technology based on deep learning is being used for maintaining integrity of an image and preventing illegal copy.

A watermarking technology based on deep learning embeds and extracts a watermark into/from an image by using a trained artificial intelligence model, and prevents unauthorized use of the image through such a process of embedding and extracting the watermark. In particular, based on this technology, the presence of a watermark can be detected while the state of the original copy of the image is maintained.

However, there is a problem that, although such a watermarking technology based on deep learning detects a presence of a watermark for an image similar to an image used in training an artificial intelligence model, the performance of this watermarking technology is deteriorated for other images in the aspect of strength and image quality degradation.

### SUMMARY

According to an aspect of the disclosure, an electronic apparatus includes: at least one processor including processing circuitry; and memory storing instructions; in which the instructions, when executed by the at least one processor individually or collectively, cause the electronic apparatus to: obtain information on sizes of frequency components for a plurality of color channels constituting an image, identify a color channel, from among the plurality of color channels, having a size ratio of a high frequency component that is highest among the plurality of color channels, based on a size of the high frequency component of the identified color channel for each of a plurality of areas constituting the image, identify an embedding strength of a watermark for each of the plurality of areas, embed, into the watermark, (i) information corresponding to the embedding strength for each of the plurality of areas and (ii) locations of each of the plurality of areas, and embed, into the image, the watermark in which the information corresponding to the embedding strength for each of the plurality of areas and the locations of each of the plurality of areas are embedded.

The instructions, when executed by the at least one processor individually or collectively, may further cause the electronic apparatus to: generate quantized discrete cosine transform (DCT) coefficients from a plurality of sub areas constituting each of the plurality of areas, the quantized DCT coefficients comprising at least one AC coefficient, determine a ratio of a sum of at least one AC coefficient excluding an intermediate frequency area of AC coefficients for a DC coefficient among the quantized DCT coefficients for each of the plurality of sub areas, the intermediate frequency area of AC coefficients located between the DC coefficient and the at least one AC coefficient, and identify a color channel, from among the plurality of color channels, in which an average of the ratios determined from each of the plurality of sub areas is highest as a color channel in which a complexity is highest.

The instructions, when executed by the at least one processor individually or collectively, may further cause the electronic apparatus to: increase the embedding strength of the watermark in an area from the plurality of areas in which the size ratio of the high frequency component is highest.

The instructions, when executed by the at least one processor individually or collectively, may further cause the electronic apparatus to: generate patterns corresponding to the locations of each of the plurality of areas in each of the plurality of areas, and combine bit values constituting the watermark to the generated patterns.

The instructions, when executed by the at least one processor individually or collectively, may further cause the electronic apparatus to: arrange random numbers in the patterns corresponding to the locations of each of the plurality of areas, and embed the arranged random numbers into the watermark in which the information corresponding to the embedding strength for each of the plurality of areas and the locations of each of the plurality of areas are embedded.

The instructions, when executed by the at least one processor individually or collectively, may further cause the electronic apparatus to: obtain the image in which the watermark is embedded by inputting, into an artificial intelligence model corresponding to the identified color channel among a plurality of first artificial intelligence models, the identified color channel and the watermark in which the information corresponding to the embedding strength for each of the plurality of areas and the locations of each of the plurality of areas are embedded.

The instructions, when executed by the at least one processor individually or collectively, may further cause the electronic apparatus to: based on obtaining the image into which the watermark is embedded, identify a color channel, from among the plurality of color channels, into which the watermark is embedded constituting a projected image by determining size ratios of the high frequency component of each of the plurality of color channels constituting the obtained image, identify at least one of the information on the plurality of areas from the color channel into which the watermark is embedded, identify the locations of the plurality of areas into which the watermark is embedded from at least one of the information on the plurality of areas, and based on the locations of the plurality of areas into which the watermark is embedded, extract the embedded watermark by identifying bit values constituting the watermark embedded into each of the plurality of areas.

The instructions, when executed by the at least one processor individually or collectively, may further cause the electronic apparatus to: based on the size ratios of the high frequency component for each of the plurality of areas constituting the color channel into which the watermark is embedded, identify the embedding strength embedded into the watermark for each of the plurality of areas constituting the color channel into which the watermark was embedded, and extract the watermark from the color channel into which the watermark was embedded by using the embedding strength embedded into the watermark.

The instructions, when executed by the at least one processor individually or collectively, may further cause the electronic apparatus to: extract the watermark from the color channel into which the watermark is embedded by inputting the color channel into which the watermark is embedded and the embedding strength embedded into the watermark into an artificial intelligence model corresponding to the identified color channel into which the watermark is embedded among a plurality of second artificial intelligence model.

According to an aspect of the disclosure, a controlling method of an electronic apparatus, includes obtaining information on sizes of frequency components for a plurality of color channels constituting an image; identifying a color channel, from among the plurality of color channels, having a size ratio of a high frequency component that is highest among the plurality of color channels; based on a size of the high frequency component of the identified color channel for each of a plurality of areas constituting the image, identifying an embedding strength of a watermark for each of the plurality of areas; embedding, into the watermark, (i) information corresponding to the embedding strength for each of the plurality of areas and (ii) locations of each of the plurality of areas into the watermark; and embedding, into the image, the watermark in which the information corresponding to the embedding strength for each of the plurality of areas and the locations of each of the plurality of areas are embedded.

The method may further include: generating quantized discrete cosine transform (DCT) coefficients from a plurality of sub areas constituting each of the plurality of areas; determining a ratio of a sum of at least one AC coefficient excluding an intermediate frequency area of AC coefficients for a DC coefficient among the quantized DCT coefficients for each of the plurality of sub areas, the intermediate frequency area of AC coefficients located between the DC coefficient and the at least on AC coefficient; and identifying a color channel, from among the plurality of color channels, in which an average of the ratios determined from each of the plurality of sub areas is highest as a color channel in which a complexity is highest.

The method may further include: increasing the embedding strength of the watermark in an area from the plurality of areas in which the size ratio of the high frequency component is highest.

The method may further include generating patterns corresponding to the locations of each of the plurality of areas in each of the plurality of areas; and combining bit values constituting the watermark to the generated patterns.

The method may further include: arranging random numbers in the patterns corresponding to the locations of each of the plurality of areas; and embedding the arranged random numbers into the watermark in which the information corresponding to the embedding strength for each of the plurality of areas and the locations of each of the plurality of areas are embedded.

The method may further include obtaining the image in which the information corresponding to the embedding strength for each of the plurality of areas and the locations of each of the plurality of areas are embedded by inputting, into an artificial intelligence model corresponding to the identified color channel among a plurality of first artificial intelligence models, the identified color channel and the watermark in which the information corresponding to the embedding strength for each of the plurality of areas and the locations of each of the plurality of areas are embedded.

According to an aspect of the disclosure, a non-transitory computer readable medium having instructions stored therein, which when executed by a processor of an electronic apparatus, cause the processor to execute a method including: obtaining information on sizes of frequency components for a plurality of color channels constituting an image; identifying a color channel, from among the plurality of color channels, having a size ratio of a high frequency component that is highest among the plurality of color channels; based on a size of the high frequency component of the identified color channel for each of a plurality of areas constituting the image, identifying an embedding strength of a watermark for each of the plurality of areas; embedding, into the watermark, (i) information corresponding to the embedding strength for each of the plurality of areas and (ii) locations of each of the plurality of areas into the watermark; and embedding, into the image, the watermark in which the information corresponding to the embedding strength for each of the plurality of areas and the locations of each of the plurality of areas are embedded.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram for illustrating an operation of an electronic apparatus according to one or more embodiments of the disclosure;

FIG. 2 is a block diagram for illustrating a configuration of an electronic apparatus according to an embodiment of the disclosure;

FIG. 3 is a flow chart for illustrating a method for an electronic apparatus to identify a color channel for embedding a watermark among a plurality of color channels constituting an image according to an embodiment of the disclosure;

FIG. 4 is a flow chart for illustrating a detailed method for an electronic apparatus to identify complexity of a color channel constituting an image according to an embodiment of the disclosure;

FIG. 5 and FIG. 6 are diagrams for illustrating a method for an electronic apparatus to identify complexity of a color channel according to an embodiment of the disclosure;

FIG. 7 is a flow chart for illustrating a method for an electronic apparatus to embed a watermark into a color channel wherein the complexity is the highest among a plurality of color channels constituting an image according to an embodiment of the disclosure;

FIG. 8 to FIG. 13 are diagrams for illustrating a method for an electronic apparatus to embed a watermark into a color channel wherein the complexity is the highest among a plurality of color channels constituting an image according to an embodiment of the disclosure;

FIG. 14 is a flow chart for illustrating a method for an electronic apparatus to extract a watermark from an image into which the watermark was embedded according to an embodiment of the disclosure;

FIG. 15 is a diagram for illustrating a method for an electronic apparatus to extract a watermark from an image into which the watermark was embedded according to an embodiment of the disclosure; and

FIG. 16 is a flow chart for illustrating a controlling method of an electronic apparatus according to an embodiment of the disclosure.

### DETAILED DESCRIPTION

Various modifications may be made to the embodiments of the disclosure, and there may be various types of embodiments. Accordingly, specific embodiments will be illustrated in drawings, and the embodiments will be described in detail in the detailed description. However, it should be noted that the various embodiments are not for limiting the scope of the disclosure to a specific embodiment, but they should be interpreted to include various modifications, equivalents, and/or alternatives of the embodiments of the disclosure. Also, with respect to the detailed description of the drawings, similar components may be designated by similar reference numerals.

Also, in describing the disclosure, in case it is determined that detailed explanation of related known functions or features may unnecessarily confuse the gist of the disclosure, the detailed explanation will be omitted.

In addition, the embodiments described below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

Also, the terms used in the disclosure are used only to explain specific embodiments, and are not intended to limit the scope of the disclosure. Further, singular expressions include plural expressions, unless defined obviously differently in the context.

In addition, in the disclosure, expressions such as “have,” “may have,” “include,” and “may include” denote the existence of such characteristics (e.g.: elements such as numbers, functions, operations, and components), and do not exclude the existence of additional characteristics.

Also, in the disclosure, the expressions “A or B,” “at least one of A and B,” “at least one of A or B,” or “one or more of A and/or B” and the like may include all possible combinations of the listed items. For example, “A or B,” “at least one of A and B,” or “at least one of A or B” may refer to all of the following cases: (1) including A, (2) including B, or (3) including A and B.

In addition, the expressions “first,” “second,” and the like used in the disclosure may describe various elements regardless of any order and/or degree of importance. Also, such expressions are used only to distinguish one element from another element, and are not intended to limit the elements.

Meanwhile, the description in the disclosure that one element (e.g.: a first element) is “(operatively or communicatively) coupled with/to” or “connected to” another element (e.g.: a second element) should be interpreted to include both the case where the one element is directly coupled to the another element, and the case where the one element is coupled to the another element through still another element (e.g.: a third element).

In contrast, the description that one element (e.g.: a first element) is “directly coupled” or “directly connected” to another element (e.g.: a second element) can be interpreted to mean that still another element (e.g.: a third element) does not exist between the one element and the another element.

Also, the expression “configured to” used in the disclosure may be interchangeably used with other expressions such as “suitable for,” “having the capacity to,” “designed to,” “adapted to,” “made to,” and “capable of,” depending on cases. Meanwhile, the term “configured to” may not necessarily mean that an apparatus is “specifically designed to” in terms of hardware.

Instead, under some circumstances, the expression “an apparatus configured to” may mean that the apparatus “is capable of” performing an operation together with another apparatus or component. For example, the phrase “a processor configured to perform A, B, and C” may mean a dedicated processor (e.g.: an embedded processor) for performing the corresponding operations, or a generic-purpose processor (e.g.: a CPU or an application processor) that can perform the corresponding operations by executing one or more software programs stored in a memory device.

Further, in the embodiments of the disclosure, ‘a module’ or ‘a part’ may perform at least one function or operation, and may be implemented as hardware or software, or as a combination of hardware and software. Also, a plurality of ‘modules’ or ‘parts’ may be integrated into at least one module and implemented as at least one processor, excluding ‘a module’ or ‘a part’ that needs to be implemented as specific hardware.

Meanwhile, various elements and areas in the drawings were illustrated schematically. Accordingly, the technical idea of the disclosure is not limited by the relative sizes or intervals illustrated in the accompanying drawings.

Hereinafter, the embodiments according to the disclosure will be described in detail with reference to the accompanying drawings, such that those having ordinary skill in the art to which the disclosure belongs can easily carry out the disclosure.

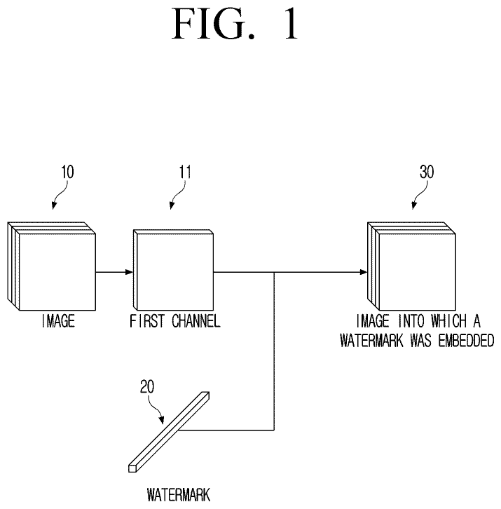

FIG. 1 is a diagram for illustrating an operation of an electronic apparatus according to an embodiment of the disclosure.

Referring to FIG. 1, an electronic apparatus 100 may obtain an image 10. The image 10 may be an image which becomes a subject for embedding of a watermark.

The image 10 may include a plurality of color channels. The electronic apparatus 100 may embed a watermark 20 into one color channel 11 among the plurality of color channels constituting the image 10.

The watermark 20 may refer to information for prevention of illegal copy of an image or information for indicating metadata of an image.

Accordingly, the electronic apparatus 100 may obtain an image 30 in which the watermark 20 was embedded into a first color channel 11.

A detailed method for the electronic apparatus 100 to embed a watermark into an image will be explained with reference to the drawings below.

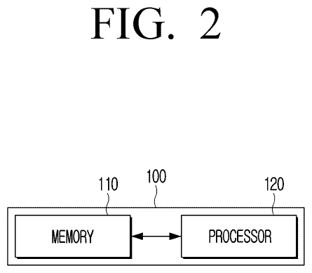

FIG. 2 is a block diagram for illustrating a configuration of an electronic apparatus according to an embodiment of the disclosure.

The electronic apparatus 100 may include memory 110 and a processor 120. The electronic apparatus 100 may further include different components other than the above components.

The electronic apparatus 100 may be implemented as a server, but this is merely an example, and the electronic apparatus 100 may be implemented in various forms such as a smartphone, a TV, a smart TV, a set-top box, a mobile phone, a personal digital assistant (PDA), a laptop, a media player, an electronic book terminal, a terminal for digital broadcasting, a navigation, a kiosk, an MP3 player, a wearable apparatus, a home appliance, and other mobile or non-mobile computing apparatuses, etc.

The memory 110 may store at least one instruction regarding the electronic apparatus 100. The memory 110 may store an operating system (O/S) for driving the electronic apparatus 100. Also, the memory 110 may store various kinds of software programs or applications for the electronic apparatus 100 to operate according to the various embodiments of the disclosure. In addition, the memory 110 may include semiconductor memory such as flash memory or a magnetic storage medium such as a hard disk, etc.

In particular, the memory 110 may store information on an image for embedding a watermark. Also, the memory 110 may store information on a watermark for embedding into an image.

The processor 120 may control the overall operations and functions of the electronic apparatus 100. Specifically, the processor 120 may be connected with the components of the electronic apparatus 100 including the memory 110, and control the overall operations of the electronic apparatus 100 by executing the at least one instruction stored in the memory 110 as described above. Although FIG. 2 illustrates an example of an electronic apparatus 100, the embodiments are not limited to this configuration. For example, the embodiments of the present disclosure may be performed in a distributed system in which an electronic apparatus communicates with one or more servers where one or more tasks are split between the electronic apparatus and the one or more servers.

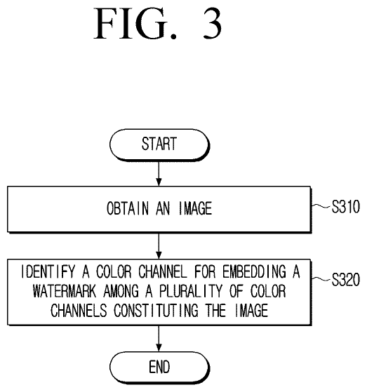

FIG. 3 is a flow chart for illustrating a method for an electronic apparatus to identify a color channel for embedding a watermark among a plurality of color channels constituting an image according to an embodiment of the disclosure.

Referring to FIG. 3, the electronic apparatus 100 may obtain an image in the step S310.

The image may be an image which becomes a subject for embedding of a watermark. In one or more examples, the image may be an image stored in the memory 110 in advance, or an image received by the electronic apparatus 100 from an external apparatus.

The image may consist of a plurality of color channels. For example, the image may consist of R, G, B channels. In one or more examples, the image may consist of Y, Cb, Cr channels.

In the disclosure, “a color channel” may be replaced by a term of an identical or similar concept such as “a channel,” “a component,” “an element,” or “a layer.”

A watermark embedded into the image may consist of a plurality of bits. For example, a watermark may be expressed as a sequence of bits of which values are expressed as 0 or 1. For example, a watermark may be expressed as “1101100101 . . . .”

In the disclosure, “a watermark” may be replaced by a term of an identical/a similar concept such as “a message,” “an image,” “a text,” “a digital watermark,” “a digital signature,” “a logo,” “a mark,” “a hidden tag,” “an invisible watermark,” or “a hidden watermark,” etc. In one or more examples, a watermark embedded in an image is visible. In one or more embodiments, a watermark embedded in an image is not visible. In one or more examples, an image may include more than one watermark. For example, the image may contain a first watermark that is visible and a second watermark that is not visible. In one or more examples, each watermark in an image may be visible or not visible.

The electronic apparatus 100 may divide the image into a plurality of areas. Then, the electronic apparatus 100 may divide each of the plurality of areas into a plurality of sub areas.

The electronic apparatus 100 may divide the image into a plurality of areas including pixels of a first number. Then, the electronic apparatus 100 may divide each of the plurality of areas into a plurality of sub areas including pixels of a second number. For example, each area may include N pixels, and each sub-area may include M pixels, where N>M. For example, an area may include 100 pixels that are subsequently divided into 4 sub-areas with each sub-area including 25 pixels.

Also, the electronic apparatus 100 may divide each of a plurality of color channels constituting the image into a plurality of areas including pixels of the first number. Then, the electronic apparatus 100 may divide each of the plurality of areas constituting the color channel into a plurality of sub areas including pixels of the second number.

For example, the electronic apparatus 100 may divide the image or the color channel into a plurality of areas (e.g., a first area, a second area, . . . , an nth area) consisting of 16×16 pixels. Then, the electronic apparatus 100 may divide each of the plurality of areas into a plurality of sub areas (e.g., a first sub area, a second sub area, a third sub area, and a fourth sub area) including 8×8 pixels.

In the disclosure, “an area” may be replaced by a term of an identical/a similar concept such as “a block” or “an image block,” etc. For example, “a plurality of areas” constituting an image may be replaced by “a plurality of image blocks,” and “a plurality of sub areas” may be replaced by “a plurality of sub image blocks.”

The electronic apparatus 100 may identify a channel for embedding the watermark among the plurality of color channels constituting the image in the step S320.

For example, in case the image consists of R, G, B channels, the electronic apparatus 100 may identify one of the R, G, B channels as a color channel for embedding the watermark.

The electronic apparatus 100 may identify a color channel wherein the complexity is the highest among the plurality of color channels constituting the image. The electronic apparatus 100 may identify the color channel wherein the complexity is the highest among the plurality of color channels as a channel for embedding the watermark. Here, the channel for embedding the watermark may be referred to as “an embedding channel.”

“Complexity” of a color channel may mean the degree indicating how diverse and fine visual elements are in the color channel, and how much they interact. As the complexity of a color channel is higher, a watermark may be embedded more strongly. That is, as the complexity of a color channel is higher, a watermark may be embedded in higher embedding strength. Here, the watermark may be embedded in strength that is difficult to be detected with the naked eye.

In the disclosure, “complexity” may be replaced by a term of an identical/a similar concept such as “a degree of precision,” “an amount of change,” “a rate of change,” etc.

In case the complexity of a color channel is high, one pixel constituting the color channel may have a big difference from an adjacent pixel. One pixel having a big difference from an adjacent pixel may have a high spatial frequency (a high frequency) component.

In case the complexity of a color channel is low, one pixel constituting the color channel may have a small difference from an adjacent pixel. One pixel having a small difference from an adjacent pixel may have a low spatial frequency (a low frequency) component.

“Complexity” of a color channel may be determined by a high frequency component among frequency components constituting the color channel. A frequency of a color channel may be a measure indicating how much spatial change of the color channel occurs.

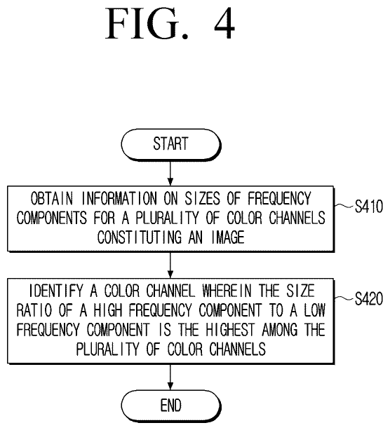

Accordingly, the electronic apparatus 100 may identify the complexity of a color channel based on the size of a high frequency component among frequency components constituting the color channel. Explanation in this regard will be described with reference to FIG. 4.

FIG. 4 is a flow chart for illustrating a detailed method for an electronic apparatus to identify complexity of a color channel constituting an image according to an embodiment of the disclosure.

Referring to FIG. 4, the electronic apparatus 100 may obtain information on sizes of frequency components for a plurality of color channels constituting an image in the step S410.

For example, in case an image consists of R, G, B channels, the electronic apparatus 100 may identify the sizes of frequency components for the R channel, the sizes of frequency components for the G channel, and the sizes of frequency components for the B channel.

The electronic apparatus 100 may perform general discrete cosine transform (DCT) for each of a plurality of sub areas constituting a color channel, and convert pixel values of a spatial area into components of a frequency area. Here, the frequency components in the plurality of sub areas may be expressed as DCT coefficients. That is, the electronic apparatus 100 may perform general discrete cosine transform for each of the plurality of sub areas, and generate a plurality of DCT coefficients. Here, the plurality of DCT coefficients may be referred to as “DCT blocks.”

Then, the electronic apparatus 100 may perform quantization for the plurality of obtained DCT coefficients, and obtain a plurality of quantized DCT coefficients.

That is, for each of the plurality of color channels, the electronic apparatus 100 may obtain a plurality of quantized discrete cosine transform (DCT) coefficients from the plurality of sub areas constituting each of the plurality of areas.

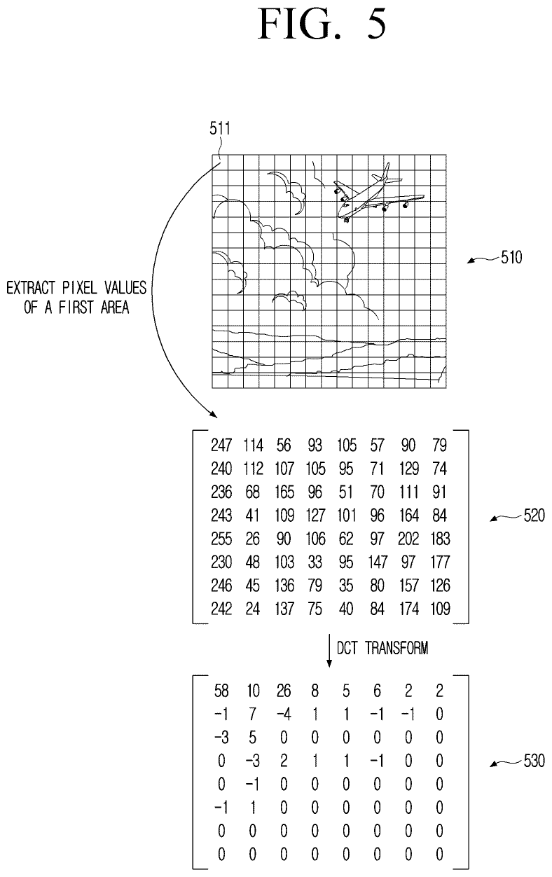

For example, referring to FIG. 5, the electronic apparatus 100 may extract a pixel value 520 of one area 511 among the plurality of areas constituting one color channel 510 among the plurality of color channels. Here, the one area 511 among the plurality of areas may consist of 8×8 pixels. Then, the electronic apparatus 100 may perform DCT transform for the pixel value 520 of the one area 511, and generate a plurality of DCT coefficients 530 for the one area 511. Here, on the upper left end of the plurality of DCT coefficients 530, a low frequency component may be arranged, and on the right lower end, a high frequency component may be arranged.

The electronic apparatus 100 may identify a color channel wherein a size ratio of the high frequency component to the low frequency component is the highest among the plurality of color channels in the step S420. The electronic apparatus 100 may identify the color channel wherein the size ratio of the high frequency component is the highest among the plurality of color channels as a channel to embed a watermark.

For example, the electronic apparatus 100 may calculate a value of a sum of at least one AC coefficient for a DC coefficient among the quantized DCT coefficients for each of the plurality of sub areas. As understood by one or ordinary skill in the art, the DCT coefficients may be divided into AC coefficients and DC coefficients, where the DC coefficients are the DCT coefficients with zero frequency in both dimensions, and the AC coefficients are the remaining DCT coefficients with non-zero frequencies.

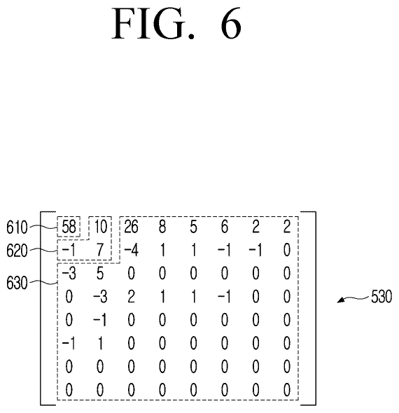

For example, referring to FIG. 6, the plurality of DCT coefficients 530 obtained from the first area 511 may include a DC coefficient 610 and a plurality of AC coefficients 620, 630.

Here, the DC coefficient 610 may be a coefficient corresponding to the low frequency component, and the plurality of AC coefficients 620, 630 may be coefficients corresponding to the high frequency component.

Here, the electronic apparatus 100 may calculate a sum of at least one AC coefficient 630 for the DC coefficient 610. Here, the at least one AC coefficient 630 may be a coefficient excluding the AC coefficient 620 close to the low frequency component among the plurality of AC coefficients 620, 630. In one or more examples, the AC coefficient 620 close to the low frequency component may mean the AC coefficient 620 arranged in an area adjacent to the DC coefficient 610.

In one or more examples, the electronic apparatus 100 may calculate a ratio of a sum of at least one AC coefficient excluding an intermediate frequency area for the DC coefficient among the quantized DCT coefficients for each of the plurality of sub areas. For example, the AC coefficients in area 620 may correspond to the intermediate frequency area for the DC coefficient, and the electronic apparatus 100 may calculate a ratio of a sum of the at least one AC coefficient excluding the AC coefficients 620.

The electronic apparatus 100 may calculate a size ratio of the high frequency component to the low frequency component from the obtained DCT coefficients.

The size ratio of the high frequency component to the low frequency component may be defined as in the following formula 1.

$$Size ratio of a high frequency component = \frac{\vert {a}_{s} \vert}{D C} + {\sum }_{k = s}^{n - 1} \frac{\vert {a}_{k} \vert}{D C} \qquad Formula 1$$

Here, DC may mean a value of a DC coefficient. Meanwhile, ak may mean an AC coefficient of which degree is k.

That is, the electronic apparatus 100 may exclude AC coefficients of which degrees are 1, 2, and 4 among the plurality of AC coefficients. Here, the AC coefficients of which degrees are 1, 2, and 4 may mean AC coefficients arranged in areas adjacent to the DC coefficient among the plurality of AC coefficients.

That is, the electronic apparatus 100 may calculate a size ratio of the at least one AC coefficient 630 for the DC coefficient 610 among the plurality of DCT coefficients 530.

The electronic apparatus 100 may calculate a size ratio of a high frequency component to a low frequency component for each of the plurality of sub areas according to the aforementioned method. Then, the electronic apparatus 100 may identify a color channel wherein the average value of the size ratios of the high frequency components to the low frequency components calculated from each of the plurality of sub areas is the highest as a channel wherein the complexity is the highest.

Accordingly, the electronic apparatus 100 may identify a color channel that is the most appropriate for embedding a watermark. A color channel that is the most appropriate for embedding a watermark may mean a color channel wherein the complexity is high to a degree that it is difficult to detect a watermark with the naked eye even if the watermark is embedded in high embedding strength.

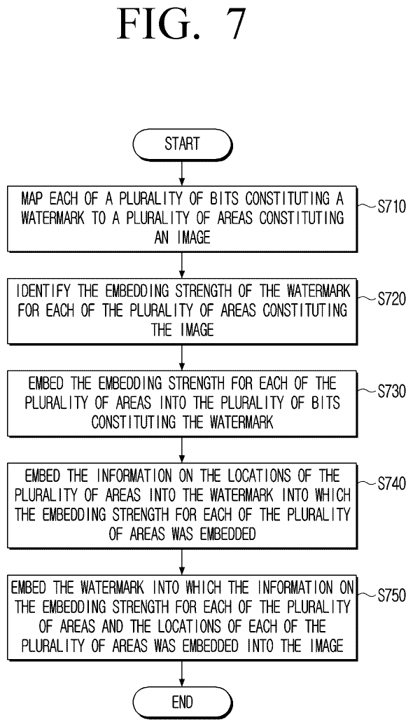

When a color channel having the highest complexity among the plurality of color channels constituting the image is identified according to the aforementioned method, the electronic apparatus 100 may embed the watermark into the identified color channel. Explanation in this regard will be described with reference to FIG. 7.

FIG. 7 is a flow chart for illustrating a method for an electronic apparatus to embed a watermark into a color channel wherein the complexity is the highest among a plurality of color channels constituting an image according to an embodiment of the disclosure.

Referring to FIG. 7, the electronic apparatus 100 may map a plurality of bits constituting a watermark to a plurality of areas constituting an image in the step S710.

Specifically, the electronic apparatus 100 may obtain a plurality of bits constituting a watermark. The watermark may be implemented in a form of an image, a text, or an audio signal, and the electronic apparatus 100 may convert the watermark into a sequence of a plurality of bits. For example, the electronic apparatus 100 may convert the watermark into “1101100101 . . . ,” which is a sequence of a plurality of bits. Here, the obtained sequence of a plurality of bits may be referred to as a plurality of bits constituting the watermark.

Alternatively, the plurality of bits constituting the watermark may be stored in the memory 110 in advance. The electronic apparatus 100 may load the plurality of bits stored in the memory 110 in advance.

When the plurality of bits constituting the watermark is obtained, the electronic apparatus 100 may map each of the plurality of bits to the plurality of areas constituting the image.

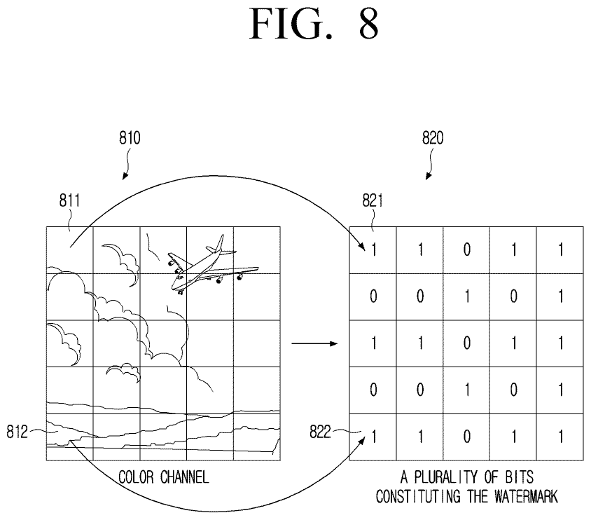

For example, referring to FIG. 8, the electronic apparatus 100 may divide the first color channel 810 into a plurality of areas. Here, the first color channel 810 may be a color channel wherein the complexity is the highest among the plurality of color channels constituting the image.

The electronic apparatus 100 may obtain a plurality of bits 820 mapped to each of the plurality of areas. The electronic apparatus 100 may map the first bit 821 among the plurality of bits 820 to the first area 811 among the plurality of areas. Then, the electronic apparatus 100 may map the second bit 822 among the plurality of bits 820 to the second area 812 among the plurality of areas. Based on the mapped information, the electronic apparatus 100 may embed information on the first bit 821 into the first area 811, and embed information on the second bit 822 into the second area 821.

That is, the electronic apparatus 100 may generate a matrix including information on the plurality of bits 820. Here, the matrix generated by the electronic apparatus 100 may be referred to as “a watermark matrix,” “a watermark bit matrix,” “a bit matrix,” or “a message matrix,” etc.

Here, each element included in the generated matrix may correspond to one bit among the plurality of bits. The number of elements included in the matrix may correspond to the number of the plurality of areas. Also, the locations of each element included in the matrix may correspond to the locations of each of the plurality of areas. For example, in case the plurality of areas are 5×5, the number of the elements of the matrix may be 5×5. Also, the information on the first bit 821 located in the first row, the first column in the generated matrix may be embedded into the first area 811 of the color channel. Further, the information on the second bit 822 located in the fourth row, the first column may be embedded into the second area 812 of the color channel.

In one or more examples, the number of the plurality of bits constituting the watermark may be smaller than the number of the plurality of areas constituting the image. In this case, the electronic apparatus 100 may repeatedly embed the bits constituting the watermark.

For example, if the number of the plurality of areas constituting the image is 8,040, and the number of the plurality of bits constituting the watermark is 804, the electronic apparatus 100 may embed each of the bits constituting the watermark 10 times. That is, the electronic apparatus 100 may embed the bits constituting the watermark once from the first area to the 804th area. Then, the electronic apparatus 100 may embed the bits constituting the watermark once from the 805th area to the 1608th area. That is, the electronic apparatus 100 may embed the information on the first bit among the plurality of bits into the first area, the 805th area, the 1609th area, etc.

When embedding one of the bits constituting the watermark into each of the plurality of areas constituting the image, the electronic apparatus 100 may embed the bits by varying the embedding strength. That is, the electronic apparatus 100 may identify the embedding strength of the watermark for each of the plurality of areas constituting the image in the step S720.

“Embedding strength” of the watermark may mean a value indicating the size or the strength of the watermark signal. As the embedding strength is higher, the watermark can be extracted more easily, but the quality of the original data may be deteriorated. In one or more examples, as the embedding strength is lower, the quality of the original data can be maintained, but extraction of the watermark may become more difficult.

“Embedding strength” in the disclosure may be replaced by a term of an identical/a similar concept such as “a weight”, “an inserting weight”, “an inserting degree”, “an inserting level”, “an embedding weight”, “an embedding degree” and “an embedding level”.

Specifically, the electronic apparatus 100 may embed the first bit into the first area among the plurality of areas constituting the image in accordance with a first embedding strength, embed the second bit into the second area in accordance with a second embedding strength, and embed the third bit into the third area in accordance with a third embedding strength.

Specifically, the electronic apparatus 100 may identify the embedding strength for each of a plurality of areas constituting a color channel based on the complexity of each of the plurality of areas constituting the color channel.

The electronic apparatus 100 may identify the embedding strength of the watermark for each of the plurality of areas based on the complexity of the identified color channel for each of the plurality of areas constituting the image. The electronic apparatus 100 may increase the embedding strength of the watermark in an area wherein the complexity is high among the plurality of areas constituting the image. Accordingly, a first area with a higher complexity than a second area may have a higher embedding strength than the second area.

Here, at least a part of the method for the electronic apparatus 100 to identify the complexity of the identified color channel for each of the plurality of areas may be identical to the aforementioned method.

Specifically, the electronic apparatus 100 may identify a plurality of sub areas constituting one area among the plurality of areas constituting the image. Then, the electronic apparatus 100 may respectively calculate the size ratio of a high frequency component to a low frequency component of the color channel of each of the plurality of sub areas. Then, the electronic apparatus 100 may identify the average of the values (or the ratios) calculated from each of the plurality of sub areas constituting the one area as the complexity of the one area. Then, the electronic apparatus 100 may map the embedding strength corresponding to the identified complexity of the one area to the one area.

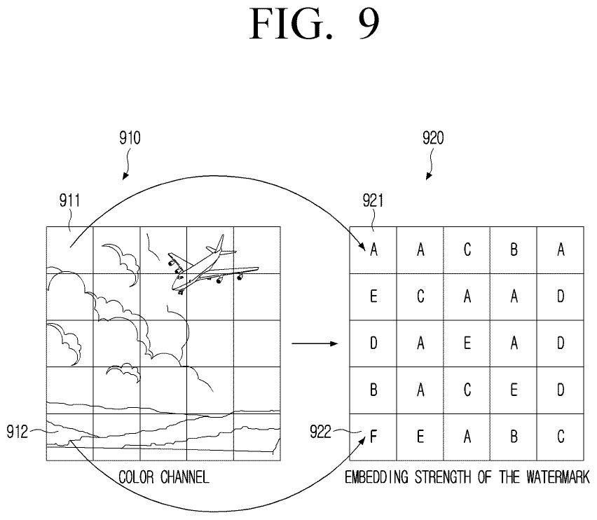

For example, referring to FIG. 9, the electronic apparatus 100 may divide the color channel 910 into a plurality of areas. Here, the color channel 910 may be a color channel wherein the complexity is the highest among the plurality of color channels constituting the image. The electronic apparatus 100 may obtain the embedding strength 920 mapped to each of the plurality of areas.

Specifically, if the complexity of the first area 911 among the plurality of areas constituting the image belongs to the first range, the electronic apparatus 100 may identify the embedding strength of the first area 911 as an A level 921. Also, if the complexity of the second area 912 among the plurality of areas belongs to the second range of which complexity is higher than the first range, the electronic apparatus 100 may identify the embedding strength of the second area 912 as an F level 922 higher than the A level.

That is, the electronic apparatus 100 may generate a matrix indicating the embedding strength for each of the plurality of areas.

The embedding strength of the watermark for each of the plurality of areas may be expressed as one of a plurality of discrete levels such as an A level, a B level, a C level, a D level, an E level, and an F level, but is not limited thereto. Here, the embedding strength according to each level may be expressed as discrete integers, fractional numbers, or a mix of both such as “1”, “1.5”, “2”, “2.5”, “3,” and “3.5.”

When the embedding strength for each of the plurality of areas is identified, the electronic apparatus 100 may embed the embedding strength for each of the plurality of areas into the plurality of bits constituting the watermark in the step S730.

Specifically, the electronic apparatus 100 may reflect the embedding strength to the plurality of bits by multiplying the bits mapped to each of the plurality of areas by the embedding strength corresponding to each of the plurality of areas.

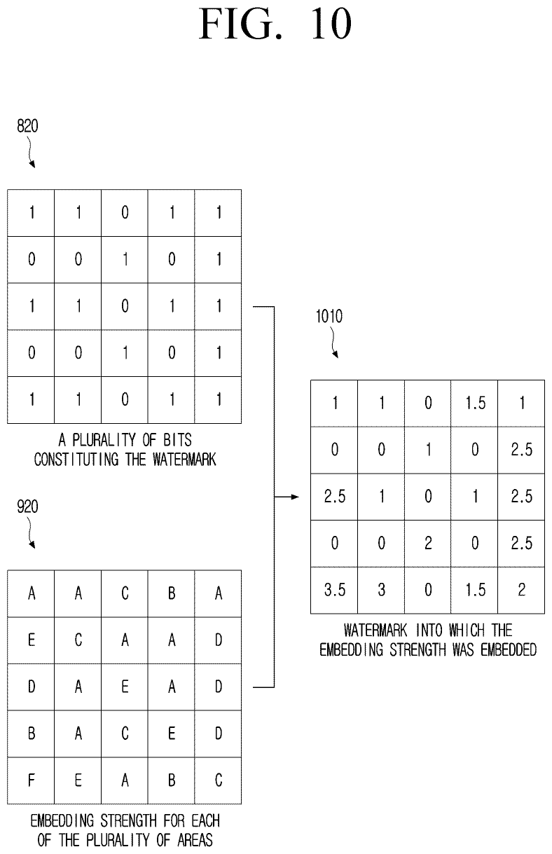

For example, referring to FIG. 10, the plurality of bits 820 constituting the watermark may consist of “1101100101 . . . .” Here, the bit mapped to the first area among the plurality of bits 820 may be 1, the bit mapped to the second area may be 1, and the bit mapped to the third area may be 0. Also, according to the embedding strength 920 for each of the plurality of areas, the first embedding strength corresponding to the first area, the second embedding strength corresponding to the second area, and the third embedding strength corresponding to the third area may respectively be the A level, the A level, and the C level. Here, the embedding strength corresponding to the A level and the C level may be 1 and 2, respectively.

The electronic apparatus 100 may embed 1 which is a result of multiplying 1 which is the first bit among the bits constituting the watermark by 1 which is the first embedding strength into the first area. The electronic apparatus 100 may embed 1 which is a result of multiplying 1, which is the second bit among the bits constituting the watermark, by 1, which is the second embedding strength, into the second area. The electronic apparatus 100 may embed information on 0, which is a result of multiplying 0, which is the third bit among the bits constituting the watermark, by 2, which is the third embedding strength into the third area. That is, the watermark 1010 into which the embedding strength was embedded may be “{1}, {1}, {0}, . . . .”

Accordingly, the electronic apparatus 100 may obtain information on the watermark 1010 into which the embedding strength for each of the plurality of areas was embedded.

In one or more examples, when embedding the bits constituting the watermark into the plurality of areas constituting the image, the electronic apparatus 100 may embed location information corresponding to each of the plurality of areas into the watermark, and embed the watermark into which the location information was embedded into the plurality of areas.

For example, the electronic apparatus 100 may embed the information on the locations of the plurality of areas into the watermark 710 into which the embedding strength for each of the plurality of areas was embedded in the step S740.

Specifically, the electronic apparatus 100 may generate patterns corresponding to the locations of each of the plurality of areas. Here, the generated patterns may be expressed as an image or a matrix.

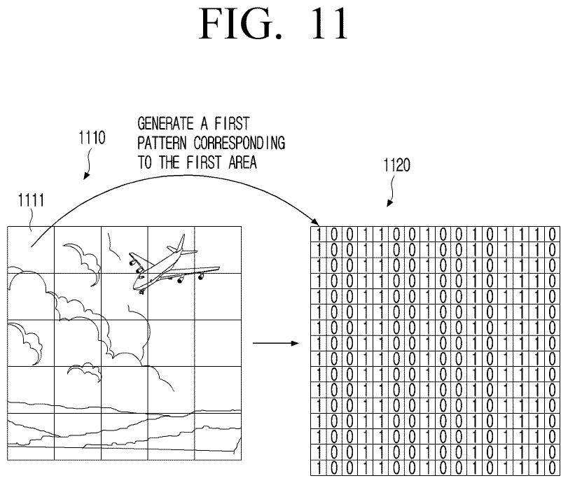

For example, as illustrated in FIG. 11, the electronic apparatus 100 may generate a first pattern 1120 corresponding to a first area 1111 among a plurality of areas constituting a first color channel 1110 among a plurality of color channels constituting an image. The first color channel 1110 may be a color channel wherein the complexity is the highest among the plurality of color channels constituting the image. The generated first pattern 1120 may mean a pattern wherein random numbers are arranged in a pattern corresponding to the first area in a matrix corresponding to the number of pixels included in the first area 1111.

That is, the electronic apparatus 100 may arrange random numbers corresponding to the number of pixels for each of the plurality of areas. For example, in case each of the plurality of areas consists of 16×16 pixels, the electronic apparatus 100 may arrange random numbers in a form of a 16×16 matrix.

The patterns corresponding to each of the plurality of areas constituting the image may be different from one another. That is, the pattern corresponding to the first area and the pattern corresponding to the second area among the plurality of areas may be different such that each area may be distinguished by a respective area.

Then, the electronic apparatus 100 may embed the generated patterns into the plurality of bits constituting the watermark. Specifically, the electronic apparatus 100 may embed the information on the locations of each of the plurality of areas into the plurality of bits by multiplying each of the bits to which the embedding strength was reflected by the matrix indicating the location patterns of each of the plurality of areas.

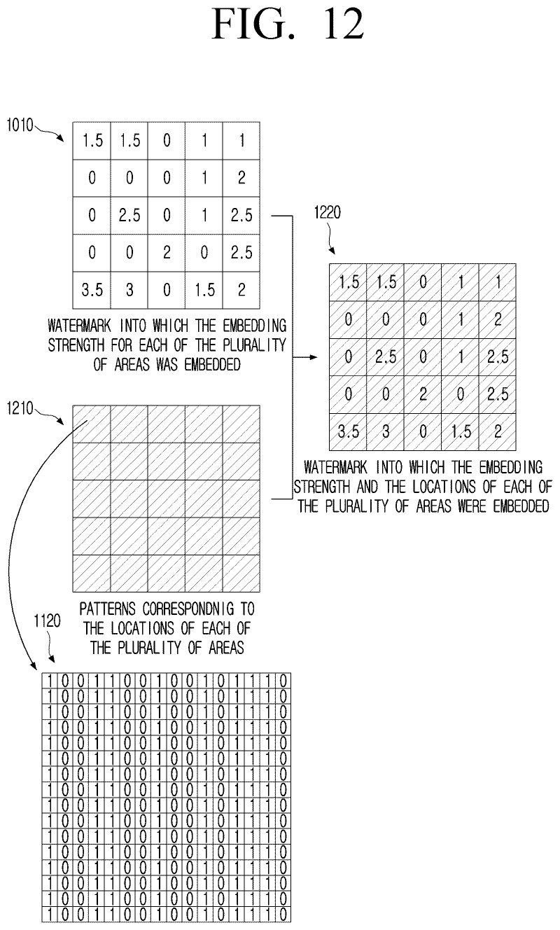

For example, as illustrated in FIG. 12, the electronic apparatus 100 may embed the patterns 1210 corresponding to the locations of each of the plurality of areas into the watermark 1010 into which the embedding strength for each of the plurality of areas was embedded, and obtain information on the watermark 1220 into which the information on the embedding strength for each of the plurality of areas and the locations of each of the plurality of areas was embedded. Specifically, the electronic apparatus 100 may obtain the first bit into which the information on the location of the first area was embedded by multiplying the random numbers arranged in the first pattern corresponding to the first area by the first bit which was mapped to the first area and to which the first embedding strength was reflected.

By the same method, the electronic apparatus 100 may obtain the second bit into which the information on the location of the second area was embedded, . . . , the nth bit into which the information on the location of the nth area was embedded, etc.

When the watermark into which the information on the embedding strength for each of the plurality of areas and the locations of each of the plurality of areas was embedded is obtained, the electronic apparatus 100 may embed the watermark into which the information on the embedding strength for each of the plurality of areas and the locations of each of the plurality of areas was embedded into the image in the step S750. Here, the electronic apparatus 100 may obtain the image into which the watermark was embedded, by inputting the watermark into which the information on the embedding strength for each of the plurality of areas and the locations of each of the plurality of areas was embedded and the image into an artificial intelligence model.

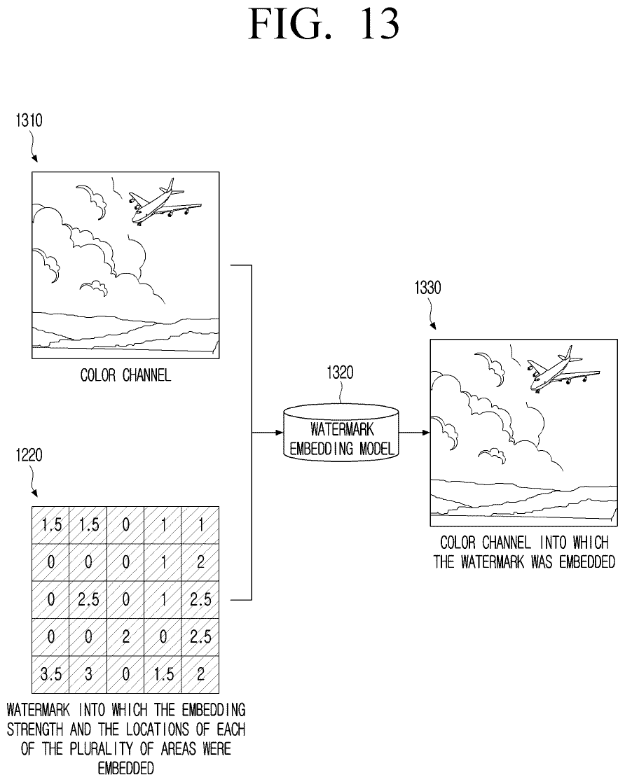

For example, referring to FIG. 13, the electronic apparatus 100 may input the watermark 1220 into which the information on the embedding strength for each of the plurality of areas and the locations of each of the plurality of areas was embedded, and the data of the color channel 1310 into which the watermark 1220 will be embedded into a watermark embedding model 1320, and obtain a color channel 1330 into which the watermark was embedded. “The watermark embedding model” may be referred to as “an artificial intelligence model” or “a neural network.”

Accordingly, the electronic apparatus 100 may embed, into one color channel among the plurality of color channels constituting the image, the watermark into which the information on the embedding strength for each of the plurality of areas and the locations of each of the plurality of areas was embedded.

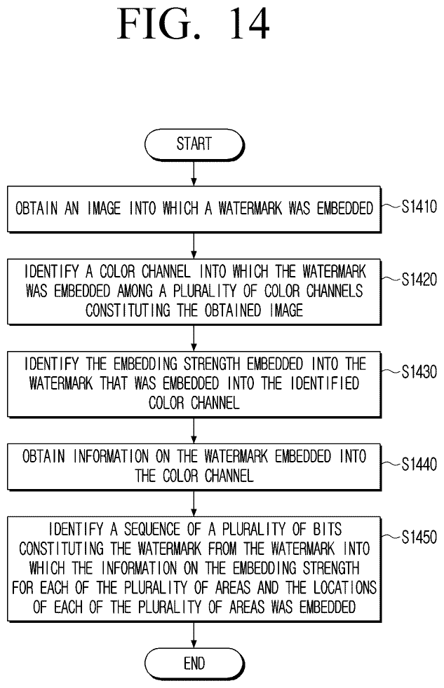

In one or more examples, the electronic apparatus 100 according to the disclosure may extract an embedded watermark from an image into which the watermark was embedded according to the aforementioned method. Explanation in this regard will be described with reference to FIG. 14.

FIG. 14 is a flow chart for illustrating a method for an electronic apparatus to extract a watermark from an image into which the watermark was embedded according to an embodiment of the disclosure.

Referring to FIG. 14, the electronic apparatus 100 may obtain an image into which a watermark was embedded in the step S1410. Here, the image may mean an image into which a watermark was embedded according to the aforementioned method. Also, here, the image may be an image wherein some parts have been modified such as compression, crop, etc. in an image into which a watermark was embedded.

The electronic apparatus 100 may receive an image into which a watermark was embedded from an external apparatus. Alternatively, if an image into which a watermark was embedded is projected on a projection surface, the electronic apparatus 100 may extract the image into which a watermark was embedded from a video that photographed the projection surface on which the image was projected.

The electronic apparatus 100 may identify a color channel into which the watermark was embedded among a plurality of color channels constituting the obtained image in the step S1420.

Specifically, the electronic apparatus 100 may identify a color channel wherein the complexity is the highest among the plurality of color channels constituting the image into which the watermark was embedded. Here, the color channel wherein the complexity is the highest may be a channel into which the watermark was embedded. That is, the electronic apparatus 100 may identify a color channel including information on the watermark, and extract the watermark from the identified color channel.

Here, the method for the electronic apparatus 100 to identify the channel wherein the complexity is the highest among the plurality of color channels constituting the image may be identical to the method explained with reference to FIG. 3 and FIG. 4.

When the color channel into which the watermark was embedded is identified, the electronic apparatus 100 may identify the embedding strength that the watermark was embedded into the identified color channel in the step S1430.

Here, the method for the electronic apparatus 100 to identify the embedding strength embedded into the watermark that was embedded into the identified color channel may be identical to the method explained in the step S720 in FIG. 7.

When the color channel into which the watermark was embedded and the embedding strength for each of the plurality of areas are identified, the electronic apparatus 100 may extract information on the watermark embedded into the color channel in the step S1440.

Specifically, the electronic apparatus 100 may input the information on the color channel and the information on the embedding strength into an artificial intelligence model, and obtain information on the watermark embedded into the color channel. Here, the artificial intelligence model may be replaced by a term such as “a watermark extraction model” or “a neural network.”

Here, the obtained information on the watermark may be the watermark into which the embedding strength for each of the plurality of areas and the locations of each of the plurality of areas were embedded.

The electronic apparatus 100 may identify a sequence of a plurality of bits constituting the watermark from the watermark into which the information on the embedding strength for each of the plurality of areas and the locations of each of the plurality of areas was embedded in the step S1450.

Specifically, the electronic apparatus 100 may identify the patterns of each of the areas into which at least one of the plurality of bits constituting the watermark was embedded from the obtained information on the watermark.

Accordingly, the electronic apparatus 100 may identify at least one area including the pattern corresponding to the area into which the nth bit among the plurality of bits constituting the watermark was embedded among the plurality of areas constituting the color channel into which the watermark was embedded.

Then, the electronic apparatus 100 may extract values for at least one bit embedded into the identified at least one area. Then, the electronic apparatus 100 may obtain a weighted average of the extracted bit values. Here, the electronic apparatus 100 may calculate the weighted average of the extracted bit values by using the embedding strength for each of the plurality of areas constituting the color channel into which the watermark was embedded. When calculating the weighted average, the electronic apparatus 100 may grant a high weight to a value extracted from an area wherein the embedding strength is high.

If the calculated weighted average is greater than or equal to a designated value, the electronic apparatus 100 may identify the value of the nth bit as “1.” If the calculated weighted average is smaller than the designated value, the electronic apparatus 100 may identify the value of the nth bit as “0.”

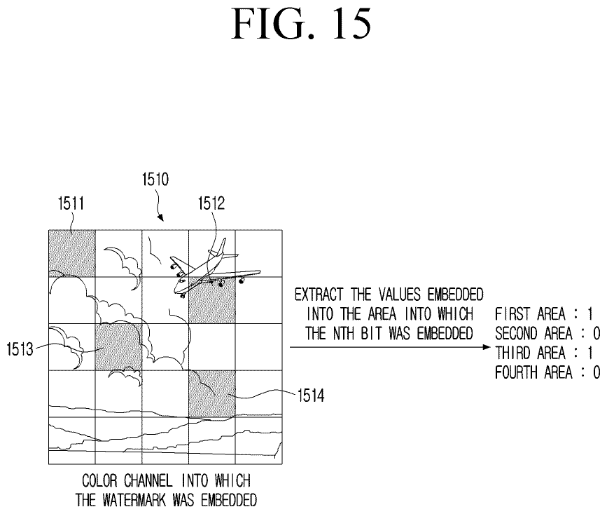

For example, referring to FIG. 15, the electronic apparatus 100 may identify a first area 1511, a second area 1512, a third area 1513, and a fourth area 1514 into which the first bit among the plurality of bits constituting the watermark was embedded in the color channel 1510 into which the watermark was embedded.

Here, the values for the bits extracted from each of the first area 1511, the second area 1512, the third area 1513, and the fourth area 1514 may be 1, 0, 1, 0.

Also, the embedding strength for each of the first area 1511, the second area 1512, the third area 1513, and the fourth area 1514 may be the A level, the B level, the C level, and the D level.

Here, the electronic apparatus 100 may obtain an average of values of multiplying the bit values extracted from each area by the values corresponding to the embedding strength of each area. The electronic apparatus 100 may obtain “1” by multiplying 1 which is a value extracted from the first area 1511 by 1 which is a value corresponding to the embedding strength A level. Then, the electronic apparatus 100 may obtain “0” by multiplying 0 which is a value extracted from the second area 1512 by 1.5 which is a value corresponding to the embedding strength B level. Then, the electronic apparatus 100 may obtain “2” by multiplying 1 which is a value extracted from the third area 1513 by 2 which is a value corresponding to the embedding strength C level. Then, the electronic apparatus 100 may obtain “0” by multiplying 0 which is a value extracted from the fourth area 1514 by 2 which is a value corresponding to the embedding strength D level. Then, the electronic apparatus 100 may calculate 1 which is an average value of the obtained values “1”, “0”, “2”, “0.” Here, as the calculated value 1 is greater than or equal to the designated value 1, the electronic apparatus 100 may identify the value of the first bit among the plurality of bits constituting the watermark as 1. The electronic apparatus 100 may identify a sequence of the plurality of bits constituting the watermark by repeatedly performing the aforementioned operation for each of the plurality of bits constituting the watermark.

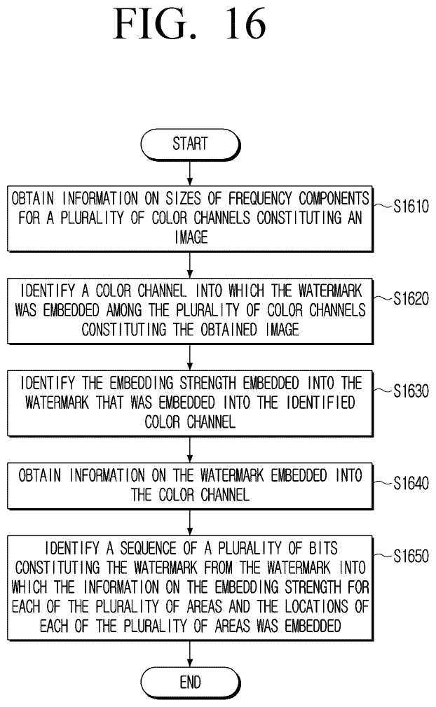

FIG. 16 is a flow chart for illustrating a controlling method of an electronic apparatus according to an embodiment of the disclosure.

Referring to FIG. 16, the electronic apparatus 100 may obtain information on sizes of frequency components for a plurality of color channels constituting an image in the step S1610.

The electronic apparatus 100 may identify a color channel wherein the size ratio of a high frequency component is the highest among the plurality of color channels in the step S1620.

According to an embodiment of the disclosure, the electronic apparatus 100 may generate quantized discrete cosine transform (DCT) coefficients from a plurality of sub areas constituting each of the plurality of areas. Then, the electronic apparatus 100 may calculate a ratio of a sum of at least one AC coefficient excluding an intermediate frequency area for a DC coefficient among the quantized DCT coefficients for each of the plurality of sub areas. The electronic apparatus 100 may identify a channel wherein the average of the ratios calculated from each of the plurality of sub areas is the highest among the plurality of channels as the channel wherein the complexity is the highest.

The electronic apparatus 100 may, based on the size of the high frequency component of the identified color channel for each of a plurality of areas constituting the image, identify the embedding strength of a watermark for each of the plurality of areas in the step S1630.

According to an embodiment of the disclosure, the electronic apparatus 100 may increase the embedding strength of the watermark in an area wherein the size ratio of the high frequency component is high among the plurality of areas.

The electronic apparatus 100 may embed information on the embedding strength for each of the plurality of areas and the locations of each of the plurality of areas into the watermark in the step S1640.

According to an embodiment of the disclosure, the electronic apparatus 100 may generate patterns corresponding to the locations of each of the plurality of areas in each of the plurality of areas. The electronic apparatus 100 may combine bit values constituting the watermark to the generated patterns.

According to an embodiment of the disclosure, the electronic apparatus 100 may arrange random numbers in the patterns corresponding to the locations of each of the plurality of areas. The electronic apparatus 100 may embed the arranged random numbers into the watermark into which the embedding strength was embedded.

The electronic apparatus 100 may embed the watermark into which the information on the embedding strength for each of the plurality of areas and the locations of each of the plurality of areas was embedded into the image in the step S1650.

According to an embodiment of the disclosure, the electronic apparatus 100 may input the watermark into which the information on the identified color channel, the embedding strength for each of the plurality of areas, and the locations of each of the plurality of areas was embedded into an artificial intelligence model corresponding to the identified channel among a plurality of first artificial intelligence models, and obtain the image into which the watermark was embedded.

According to an embodiment of the disclosure, the electronic apparatus 100 may, based on the image into which the watermark was embedded being obtained, calculate the size ratios of the high frequency components of each of the plurality of color channels constituting the obtained image and identify a color channel into which the watermark was embedded among the plurality of channels constituting the projected image. The electronic apparatus 100 may identify at least one of the information on the plurality of areas from the color channel into which the watermark was embedded. The electronic apparatus 100 may identify the locations of the plurality of areas into which the watermark was embedded from at least one of the information on the plurality of areas. The electronic apparatus 100 may, based on the locations of the plurality of areas into which the watermark was embedded, identify bit values constituting the watermark embedded into each of the plurality of areas, and extract the embedded watermark.

According to an embodiment of the disclosure, the electronic apparatus 100 may, based on the size ratios of the high frequency components for each of the plurality of areas constituting the channel into which the watermark was embedded, identify the embedding strength embedded into the watermark for each of the plurality of areas constituting the channel into which the watermark was embedded. The electronic apparatus 100 may extract the watermark from the color channel into which the watermark was embedded by using the embedding strength embedded into the watermark.

According to an embodiment of the disclosure, the electronic apparatus 100 may input the color channel into which the watermark was embedded and the embedding strength embedded into the watermark into an artificial intelligence model corresponding to the identified channel into which the watermark was embedded among a plurality of second artificial intelligence model, and extract the watermark from the channel into which the watermark was embedded.

In the above, each of the various embodiments of the disclosure was explained independently, but each embodiment does not necessarily have to be implemented solely, but may be coupled with at least one other embodiment on the whole or partially, and implemented together in one product.

Meanwhile, the term “a part” or “a module” used in the disclosure may include a unit implemented as hardware, software, or firmware, and may be interchangeably used with, for example, terms such as a logic, a logical block, a component, or circuitry, etc. In addition, “a part” or “a module” may be a component constituted as an integrated body or a minimum unit or a part thereof performing one or more functions. For example, a module may be constituted as an application-specific integrated circuit (ASIC).

Also, the various embodiments of the disclosure may be implemented as software including instructions stored in machine-readable storage media, which can be read by machines (e.g.: computers). The machines refer to apparatuses that call instructions stored in a storage medium, and can operate according to the called instructions, and the apparatuses may include the electronic apparatus 100 according to the aforementioned embodiments. In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals, and is tangible, but does not indicate whether data is stored in the storage medium semi-permanently or temporarily.

In addition, according to an embodiment of the disclosure, the method according to the various embodiments described in the disclosure may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or distributed on-line through an application store (e.g.: Play Store™). In the case of on-line distribution, at least a portion of a computer program product may be stored in a storage medium such as the server of the manufacturer, the server of the application store, and the memory of the relay server at least temporarily, or may be generated temporarily.

Further, each of the components according to the various embodiments (e.g.: a module or a program) may consist of a singular object or a plurality of objects, and among the aforementioned corresponding sub components, some sub components may be omitted, or other sub components may be further included in the various embodiments. Alternatively or additionally, some components (e.g.: a module or a program) may be integrated as an object, and perform the functions that were performed by each of the components before integration identically or in a similar manner. Operations performed by a module, a program, or other components according to the various embodiments may be executed sequentially, in parallel, repetitively, or heuristically. Or, at least some of the operations may be executed in a different order or omitted, or other operations may be added.

What is claimed is:

1. An electronic apparatus comprising:
at least one processor including processing circuitry; and
memory storing instructions,
wherein the instructions, when executed by the at least one processor individually or collectively, cause the electronic apparatus to:
obtain information on sizes of frequency components for a plurality of color channels constituting an image,
identify a color channel, from among the plurality of color channels, having a size ratio of a high frequency component that is highest among the plurality of color channels,
based on a size of the high frequency component of the identified color channel for each of a plurality of areas constituting the image, identify an embedding strength of a watermark for each of the plurality of areas,
embed, into the watermark, (i) information corresponding to the embedding strength for each of the plurality of areas and (ii) locations of each of the plurality of areas, and
embed, into the image, the watermark in which the information corresponding to the embedding strength for each of the plurality of areas and the locations of each of the plurality of areas are embedded.

2. The electronic apparatus of claim 1, wherein the instructions, when executed by the at least one processor individually or collectively, further cause the electronic apparatus to:
generate quantized discrete cosine transform (DCT) coefficients from a plurality of sub areas constituting each of the plurality of areas, the quantized DCT coefficients comprising at least one AC coefficient,
determine a ratio of a sum of at least one AC coefficient excluding an intermediate frequency area of AC coefficients for a DC coefficient among the quantized DCT coefficients for each of the plurality of sub areas, the intermediate frequency area of AC coefficients located between the DC coefficient and the at least one AC coefficient, and
identify a color channel, from among the plurality of color channels, in which an average of the ratios determined from each of the plurality of sub areas is highest as a color channel in which a complexity is highest.

3. The electronic apparatus of claim 1, wherein the instructions, when executed by the at least one processor individually or collectively, further cause the electronic apparatus to:
increase the embedding strength of the watermark in an area from the plurality of areas in which the size ratio of the high frequency component is highest.

4. The electronic apparatus of claim 1, wherein the instructions, when executed by the at least one processor individually or collectively, further cause the electronic apparatus to:
generate patterns corresponding to the locations of each of the plurality of areas in each of the plurality of areas, and
combine bit values constituting the watermark to the generated patterns.

5. The electronic apparatus of claim 4, wherein the instructions, when executed by the at least one processor individually or collectively, cause the electronic apparatus to:
arrange random numbers in the patterns corresponding to the locations of each of the plurality of areas, and
embed the arranged random numbers into the watermark in which the information corresponding to the embedding strength for each of the plurality of areas and the locations of each of the plurality of areas are embedded.

6. The electronic apparatus of claim 1, wherein the instructions, when executed by the at least one processor individually or collectively, further cause the electronic apparatus to:
obtain the image in which the watermark is embedded by inputting, into an artificial intelligence model corresponding to the identified color channel among a plurality of first artificial intelligence models, the identified color channel and the watermark in which the information corresponding to the embedding strength for each of the plurality of areas and the locations of each of the plurality of areas are embedded.

7. The electronic apparatus of claim 1, wherein the instructions, when executed by the at least one processor individually or collectively, further cause the electronic apparatus to:
based on obtaining the image into which the watermark is embedded, identify a color channel, from among the plurality of color channels, into which the watermark is embedded constituting a projected image by determining size ratios of the high frequency component of each of the plurality of color channels constituting the obtained image,
identify at least one of the information on the plurality of areas from the color channel into which the watermark is embedded,
identify the locations of the plurality of areas into which the watermark is embedded from at least one of the information on the plurality of areas, and
based on the locations of the plurality of areas into which the watermark is embedded, extract the embedded watermark by identifying bit values constituting the watermark embedded into each of the plurality of areas.

8. The electronic apparatus of claim 7, wherein the instructions, when executed by the at least one processor individually or collectively, further cause the electronic apparatus to:
based on the size ratios of the high frequency component for each of the plurality of areas constituting the color channel into which the watermark is embedded, identify the embedding strength embedded into the watermark for each of the plurality of areas constituting the color channel into which the watermark was embedded, and
extract the watermark from the color channel into which the watermark was embedded by using the embedding strength embedded into the watermark.

9. The electronic apparatus of claim 7, wherein the instructions, when executed by the at least one processor individually or collectively, further cause the electronic apparatus to:
extract the watermark from the color channel into which the watermark is embedded by inputting the color channel into which the watermark is embedded and the embedding strength embedded into the watermark into an artificial intelligence model corresponding to the identified color channel into which the watermark is embedded among a plurality of second artificial intelligence model.

10. A controlling method of an electronic apparatus, the method comprising:
obtaining information on sizes of frequency components for a plurality of color channels constituting an image;
identifying a color channel, from among the plurality of color channels, having a size ratio of a high frequency component that is highest among the plurality of color channels;
based on a size of the high frequency component of the identified color channel for each of a plurality of areas constituting the image, identifying an embedding strength of a watermark for each of the plurality of areas;
embedding, into the watermark, (i) information corresponding to the embedding strength for each of the plurality of areas and (ii) locations of each of the plurality of areas into the watermark; and
embedding, into the image, the watermark in which the information corresponding to the embedding strength for each of the plurality of areas and the locations of each of the plurality of areas are embedded.

11. The controlling method of claim 10, further comprising:
generating quantized discrete cosine transform (DCT) coefficients from a plurality of sub areas constituting each of the plurality of areas;
determining a ratio of a sum of at least one AC coefficient excluding an intermediate frequency area of AC coefficients for a DC coefficient among the quantized DCT coefficients for each of the plurality of sub areas, the intermediate frequency area of AC coefficients located between the DC coefficient and the at least on AC coefficient; and
identifying a color channel, from among the plurality of color channels, in which an average of the ratios determined from each of the plurality of sub areas is highest as a color channel in which a complexity is highest.

12. The controlling method of claim 10, further comprising:
increasing the embedding strength of the watermark in an area from the plurality of areas in which the size ratio of the high frequency component is highest.

13. The controlling method of claim 10, further comprising:
generating patterns corresponding to the locations of each of the plurality of areas in each of the plurality of areas; and
combining bit values constituting the watermark to the generated patterns.

14. The controlling method of claim 13, further comprising:
arranging random numbers in the patterns corresponding to the locations of each of the plurality of areas; and
embedding the arranged random numbers into the watermark in which the information corresponding to the embedding strength for each of the plurality of areas and the locations of each of the plurality of areas are embedded.

15. The controlling method of claim 10, further comprising:
obtaining the image in which the information corresponding to the embedding strength for each of the plurality of areas and the locations of each of the plurality of areas are embedded by inputting, into an artificial intelligence model corresponding to the identified color channel among a plurality of first artificial intelligence models, the identified color channel and the watermark in which the information corresponding to the embedding strength for each of the plurality of areas and the locations of each of the plurality of areas are embedded.

16. A non-transitory computer readable medium having instructions stored therein, which when executed by a processor of an electronic apparatus, cause the processor to execute a method comprising:
obtaining information on sizes of frequency components for a plurality of color channels constituting an image;
identifying a color channel, from among the plurality of color channels, having a size ratio of a high frequency component that is highest among the plurality of color channels;
based on a size of the high frequency component of the identified color channel for each of a plurality of areas constituting the image, identifying an embedding strength of a watermark for each of the plurality of areas;
embedding, into the watermark, (i) information corresponding to the embedding strength for each of the plurality of areas and (ii) locations of each of the plurality of areas into the watermark; and
embedding, into the image, the watermark in which the information corresponding to the embedding strength for each of the plurality of areas and the locations of each of the plurality of areas are embedded.

17. The non-transitory computer readable medium according to claim 16, wherein the method further comprises:
generating quantized discrete cosine transform (DCT) coefficients from a plurality of sub areas constituting each of the plurality of areas;
determining a ratio of a sum of at least one AC coefficient excluding an intermediate frequency area of AC coefficients for a DC coefficient among the quantized DCT coefficients for each of the plurality of sub areas, the intermediate frequency area of AC coefficients located between the DC coefficient and the at least on AC coefficient; and
identifying a color channel, from among the plurality of color channels, in which an average of the ratios determined from each of the plurality of sub areas is highest as a color channel in which a complexity is highest.

18. The non-transitory computer readable medium according to claim 16, wherein the method further comprises:
increasing the embedding strength of the watermark in an area from the plurality of areas in which the size ratio of the high frequency component is highest.

19. The non-transitory computer readable medium according to claim 16, wherein the method further comprises:
generating patterns corresponding to the locations of each of the plurality of areas in each of the plurality of areas; and
combining bit values constituting the watermark to the generated patterns.

20. The non-transitory computer readable medium according to claim 19, wherein the method further comprises:
arranging random numbers in the patterns corresponding to the locations of each of the plurality of areas; and
embedding the arranged random numbers into the watermark in which the information corresponding to the embedding strength for each of the plurality of areas and the locations of each of the plurality of areas are embedded.
